(19) United States
(12) Patent Application Publication
(10) Pub. No.: US 2025/0251716 A1
(43) Pub. Date: Aug. 7, 2025

(54) NUMERICAL CONTROL DEVICE AND EXPECTED ELECTRIC POWER CONSUMPTION CALCULATION SYSTEM

(71) Applicant: FANUC CORPORATION, Minamitsuru-gun, Yamanashi (JP)

(72) Inventors: Ryou MORIHASHI, Yamanashi (JP); Shougo SHINODA, Yamanashi (JP)

(73) Assignee: FANUC CORPORATION, Minamitsuru-gun, Yamanashi (JP)

(21) Appl. No.: 18/855,994

(22) PCT Filed: Jun. 20, 2022
(86) PCT No.: PCT/JP2022/024543

§ 371 Date: Oct. 10, 2024

(51) Int. Cl. G05B 19/416; G05B 19/406

(52) U.S. Cl. CPC G05B 19/416; G05B 19/406

(57) ABSTRACT

The present invention improves the accuracy of a predicted value of electric power consumption. In addition, by visualizing actual electric power consumption and expected electric power consumption, the present invention supports electric power consumption while facilitating comparison. This numerical control device comprises: a program storage unit for storing an operation program that operates a machine; an actual electric power consumption acquisition unit for operating the machine according to a first acceleration/deceleration setting based on the operation program, and acquiring an actual electric power consumption by calculation or measurement; an expected electric power consumption calculation unit for calculating an expected electric power consumption by adding at least the actual electric power consumption and an increase/decrease in electric power consumption of a change in acceleration/deceleration from the first acceleration/deceleration setting to a second acceleration/deceleration setting; a setting storage unit for storing at least part of information that is required for the calculation of the electric power consumption of the first acceleration/deceleration setting and the second acceleration/deceleration setting in the expected electric power consumption calculation unit; and a display unit for displaying the actual electric power consumption and the expected electric power consumption.

### TECHNICAL FIELD

The present invention relates to a numerical control device that calculates and displays an expected power consumption together with an actual power consumption, and a method of calculating the expected power consumption.

### BACKGROUND ART

From the viewpoint of economy or energy savings that have recently been the focus of much attention, it is desirable to calculate an expected value of power consumption that will be involved in a change in operation of a machine.

Patent Document 1 describes a display device and a machine tool that can display, in an easily understandable manner, what influence is exercised on the entire machining process by improvement of a machining program. Specifically, the display device described in Patent Document 1 displays information acquired from the machine tool that executes a machining program including a plurality of blocks, in the form of a plurality of program blocks identified by sequence numbers. The display device includes a data acquisition unit that acquires state information that indicates the state of the machine tool in operation as an amount of change and a time axis, and timing information that indicates predetermined timing of the machining program being executed by the machine tool; a chronological information generation unit that generates chronological information based on the state information and the timing information acquired; a superimposition unit that makes the timing indicated in the timing information coincide and superimposes a plurality of pieces of the chronological information; and a display unit that displays the superimposed pieces of chronological information. The display device acquires, as the state information, data regarding a machining state, such as a machining load, a speed, an amount of change in a machining position, and an amount of change in electric power, etc.

Patent Document 2 describes a servo motor control device capable of calculating an output of a servo motor with high accuracy. Specifically, Patent Document 2 describes that the servo motor control device for controlling the servo motor includes a storage unit that stores a torque constant specified for the servo motor in advance; a torque constant correction unit that corrects the torque constant stored in the storage unit when magnetic saturation occurs in the winding of the servo motor; and an output calculation unit that calculates an output of the servo motor based on the torque constant stored in the storage unit or the corrected torque constant calculated by the torque constant correction unit, a value related to a current of the servo motor, and a value related to a speed of the servo motor.

Patent Document 3 describes a robot program correction system for correcting a robot operation program with high accuracy. Specifically, Patent Document 3 describes that the robot program correction system includes a robot control device and a program correction device. The robot control device includes an information acquisition unit that acquires robot detection information obtained from the robot by executing the operation program; and a communication unit that transmits the acquired robot detection information to the program correction device. The program correction device includes a simulation unit that executes a simulation based on an operation program PR; a program correction unit that corrects the operation program PR based on the robot detection information so that a result of the simulation satisfies a predetermined evaluation criterion while the simulation is repeated by the simulation unit; and a communication unit that transmits a corrected operation program PRI to the robot control device. The program correction unit corrects a command speed and a command acceleration at a teaching point in the operation program PR so that a cycle time is minimized, by using information acquired from the robot control device and indicating speeds, current values, and the like of motors associated with axes.

### CITATION LIST

### Patent Document

Patent Document 1: Japanese Unexamined Patent Application, Publication No. 2019-133346

Patent Document 2: Japanese Unexamined Patent Application, Publication No. 2018-153041

Patent Document 3: Japanese Unexamined Patent Application, Publication No. 2016-16488

### DISCLOSURE OF THE INVENTION

### Problems to be Solved by the Invention

Improvement of accuracy is desired so that an accurate expected value of power consumption can be obtained. In addition, it is desired to support reduction in power consumption by facilitating comparison between an actual power consumption and an expected power consumption by way of visualization of the power consumptions.

### Means for Solving the Problems

(1) A first aspect of the present disclosure is directed to a numerical control device including: a program storage unit configured to store an operation program for operating a machine; an actual power consumption acquisition unit configured to acquire an actual power consumption by calculation or actual measurement while the machine is operated at a first acceleration/deceleration setting that is based on the operation program; an expected power consumption calculation unit configured to calculate an expected power consumption by adding at least the actual power consumption and a power consumption increment/decrement corresponding to a change in acceleration/deceleration resulting from a change from the first acceleration/deceleration setting to a second acceleration/deceleration setting; a setting value storage unit configured to store at least a part of information necessary for the expected power consumption calculation unit to calculate a power consumption at the first acceleration/deceleration setting and a power consumption at the second acceleration/deceleration setting; and a display unit configured to display the actual power consumption and the expected power consumption.

(2) A second aspect of the present disclosure is directed to a method of calculating an expected power consumption using a computer that functions as a numerical control device and includes a program storage unit storing an operation program for operating a machine, the method causing the computer to perform operations comprising: storing information necessary for calculation of a power consumption at a first acceleration/deceleration setting that is based on the operation program and a power consumption at a second acceleration/deceleration setting; acquiring an actual power consumption by calculation or actual measurement while the machine is operated at the first acceleration/deceleration setting; and calculating an expected power consumption by adding at least the actual power consumption and a power consumption increment/decrement corresponding to a change in acceleration/deceleration resulting from a change from the first acceleration/deceleration setting to the second acceleration/deceleration setting.

### Effects of the Invention

Each aspect of the present disclosure makes it possible to calculated an expected value of power consumption with improved accuracy. Furthermore, each aspect of the present disclosure can support reduction in power consumption by facilitating comparison between an actual power consumption and an expected power consumption by way of visualization of the power consumptions.

### BRIEF DESCRIPTION OF THE DRAWINGS

FIG. 1 is a block diagram illustrating a configuration of a numerical control machine tool including a numerical control device according to an embodiment of the present disclosure.

FIG. 2 is a block diagram illustrating a configuration example of a servo control device.

FIG. 3 is a block diagram illustrating a configuration of a numerical control device according to an embodiment of the present disclosure.

FIG. 4 is a characteristic diagram illustrating a change in speed over time before and after a change in acceleration/deceleration in the case of linear acceleration/deceleration.

FIG. 5 is a characteristic diagram illustrating a change in acceleration over time before and after the change in acceleration/deceleration in the case of the linear acceleration/deceleration.

FIG. 6 is a characteristic diagram illustrating a change in speed over time before the change in acceleration/deceleration.

FIG. 7 is a characteristic diagram illustrating a change in speed over time at the time of acceleration before the change in acceleration/deceleration.

FIG. 8 is a characteristic diagram illustrating a change in speed over time before and after a change in acceleration/deceleration in the case of bell-shaped acceleration/deceleration.

FIG. 9 is a characteristic diagram illustrating a change in acceleration over time before and after the change in acceleration/deceleration in the case of the bell-shaped acceleration/deceleration.

FIG. 10 is a characteristic diagram illustrating a change in speed over time before and after a change in acceleration/deceleration in the case of exponential acceleration/deceleration.

FIG. 11 is a characteristic diagram illustrating a change in acceleration over time before and after a change in acceleration/deceleration in the case of the exponential acceleration/deceleration.

FIG. 12 is a block diagram illustrating a configuration example of a display setting unit.

FIG. 13 is a diagram illustrating a first example of a graphical display on a display unit.

FIG. 14 is a diagram illustrating a second example of a graphical display on the display unit.

FIG. 15 is a characteristic diagram illustrating a total power consumption of a coolant pump, a total power consumption of a conveyor, and a total power consumption of a light in comparison with a total power consumption of a motor.

FIG. 16 is a flowchart illustrating an operation of the numerical control device according to the present embodiment.

### PREFERRED MODE FOR CARRYING OUT THE INVENTION

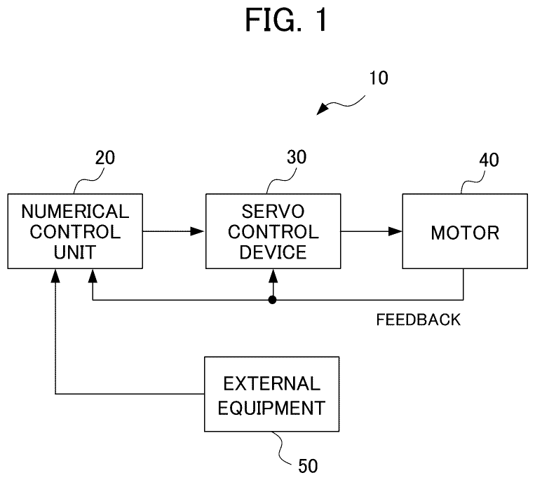

Embodiments of the present disclosure will be described with reference to the drawings. FIG. 1 is a block diagram illustrating a configuration of a numerical control machine tool including a numerical control device according to an embodiment of the present disclosure. As illustrated in FIG. 1, the numerical control machine tool 10 includes a numerical control device 20 such as a computerized numerical control (CNC) device or the like, a servo control device 30, a motor 40, and external equipment 50. The servo control device 30 controls the motor 40. In the present embodiment, a case in which the numerical control device 20 controls a machine tool, and an operation program is a machining program will be described.

The numerical control device 20 outputs a control command, such as a position command and the like, to the servo control device 30, based on the machining program that instructs a tool or a workpiece to move. The numerical control device 20 calculates an actual power consumption in a programmed operation based on feedback information from the servo control device 30, or actually measures the actual power consumption using a wattmeter, and calculates an expected power consumption in a set period in a case where an acceleration/deceleration specified in the program is changed. The numerical control device 20 then displays an electricity graph showing the actually measured power consumption and the expected power consumption on a display screen of a display unit 212, which will be described later. The numerical control device 20 may include the servo control device 30.

The servo control device 30 controls the motor 40 based on the control command, such as a position command and the like, transmitted from the numerical control device 20. The servo control device 30 includes an X-axis servo control unit for driving an X-axis motor, a Y-axis servo control unit for driving a Y-axis motor, a Z-axis servo control unit for driving a Z-axis motor, and a spindle motor control unit for driving a spindle motor. However, FIG. 1 illustrates only one servo control unit for controlling the motor 40, and the other servo control units and the spindle motor control unit are omitted.

The motor 40 is provided as a part of the machine tool. However, the motor 40 may be provided as a part of the servo control device 30. In the following description, the motor 40 is described as a motor that performs rotational motion, but the motor 40 may be a linear motor that performs linear motion.

The motor 40 is included in the machine tool such as a three-axis machine tool or the like, and functions as, for example, an X-axis feed shaft motor. In a case where the numerical control machine tool 10 is used for such a three-axis machine tool, Y-axis and Z-axis motors are further provided as feed shaft motors, and the three-axis machine tool further includes a spindle motor for rotating a tool such as a ball end mill or the like.

In the case where the motor 40 is configured as a motor that is incorporated in the three-axis machine tool and performs rotational motion, the motor 40 linearly moves a table on which a workpiece is placed in the X-axis direction via a ball screw or the like. However, the three-axis machine tool is not limited to this configuration, and may have, for example, a configuration in which a tool is fixed while a table is linearly moved in the X-axis direction, the Y-axis direction, and the Z-axis direction, or a configuration in which a table is fixed while a tool is linearly moved in the X-axis direction, the Y-axis direction, and the Z-axis direction. The machine tool is not limited to the three-axis machine tool, and may be, for example, a five-axis machine tool.

The external equipment 50 includes a coolant pump for circulating a coolant, a conveyor for collecting chips and the like, a light, etc. Although one piece of the external equipment 50 is illustrated in FIG. 1, a plurality of pieces of the external equipment 50 may be provided.

Next, a configuration and operation of the servo control device 30, those of the numerical control device 20, and those of the external equipment 50 will be described in more detail.

### Servo Control Device

In the case of the three-axis machine tool, the servo control device 30 includes the X-axis servo control unit, the Y-axis servo control unit, the Z-axis servo control unit, and the spindle motor control unit. In the following description, the X-axis servo control unit will be described as an example. The configuration of the Y-axis servo control unit and that of the Z-axis servo control unit are the same as the configuration of the X-axis servo control unit, and the configuration of the spindle motor control unit is described in Japanese Patent Application, Publication No. 2019-040556, for example.

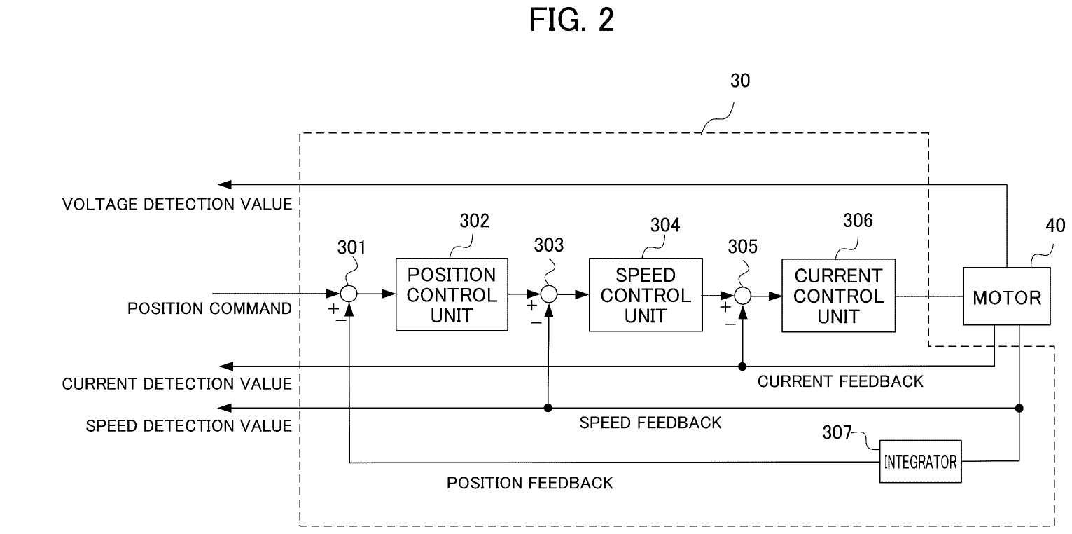

FIG. 2 is a block diagram illustrating a configuration example of the servo control device. As illustrated in FIG. 2, the servo control device 30 includes a subtracter 301, a position control unit 302, a subtracter 303, a speed control unit 304, a subtracter 305, a current control unit 306, and an integrator 307.

The subtracter 301 calculates a difference between a position command outputted from the numerical control device 20 and a detected position obtained by way of position feedback, and outputs the difference to the position control unit 302 as a position deviation. The position control unit 302 multiplies the position deviation by a position gain PG, and outputs the resulting value to the subtracter 303 as a speed command value.

The subtracter 303 calculates a difference between the speed command value outputted from the position control unit 302 and a speed detection value obtained by way of speed feedback, and outputs the difference to the speed control unit 304 as a speed deviation.

The speed control unit 304 adds an integral of a value obtained by multiplying the speed deviation by an integral gain K1v, and a value obtained by multiplying the speed deviation by a proportional gain K2v, and outputs the result to the subtracter 305 as a current command value.

The subtracter 305 calculates a difference between the current command value outputted from the speed control unit 304 and a current detection value obtained by way of current feedback, and outputs the difference to the current control unit 306 as a current deviation. The current control unit 306 generates a voltage command for driving the motor 40 based on the current deviation, and outputs the voltage command to the motor 40.

A rotational angle position of the motor 40 is detected by a rotary encoder (not shown), and a speed detection value is inputted to the subtracter 303 as speed feedback information (speed FB information). The speed detection value is inputted to the numerical control device 20. The integrator 307 integrates the speed detection value to obtain a position detection value, and inputs the position detection value to the subtracter 301 as position feedback information (position FB information). A current detector (not shown) attached to the motor 40 detects a current, and inputs the current detection value to the subtracter 305 as current feedback information (current FB information). The current detection value is inputted to the numerical control device 20. A voltage detector (not shown) attached to the motor 40 detects a voltage and inputs the voltage detection value to the numerical control device 20. As will be described later, in a case where the voltage detection value is not used in calculation of an actual power consumption, the voltage detection value does not have to be inputted to the numerical control device 20. In a case where the speed detection value is not used in the calculation of the actual power consumption, the speed detection value does not have to be inputted to the numerical control device 20.

### Numerical Control Device

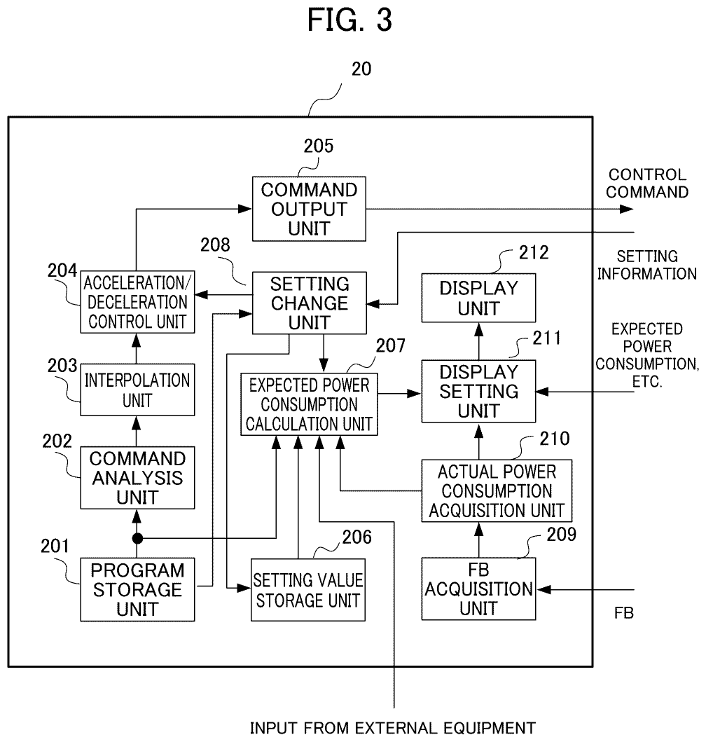

FIG. 3 is a block diagram illustrating a configuration of the numerical control device according to an embodiment of the present disclosure. As illustrated in FIG. 3, the numerical control device 20 includes a program storage unit 201, a command analysis unit 202, an interpolation unit 203, an acceleration/deceleration control unit 204, a command output unit 205, a setting value storage unit 206, an expected power consumption calculation unit 207, a setting change unit 208, a FB acquisition unit 209, an actual power consumption acquisition unit 210, a display setting unit 211, and a display unit 212.

The program storage unit 201 stores a machining program. The command analysis unit 202 sequentially reads and analyzes blocks including commands for movement of the X axis, the Y axis, the Z axis, and the spindle from the machining program, and generates movement command data for commanding movement of each axis based on the analysis result. The interpolation unit 203 generates interpolation data by performing interpolation calculation of points on a command path at an interpolation cycle, based on the movement command given by the movement command data outputted from the command analysis unit 202.

The acceleration/deceleration control unit 204 performs acceleration/deceleration processing based on the interpolation data outputted from the interpolation unit 203, calculates a machining speed for each axis for each interpolation cycle, and outputs the calculated machining speed to the command output unit 205 described later. The command output unit 205 generates a position command based on the machining speed of each axis outputted from the acceleration/deceleration control unit 204, and outputs the position command to the servo control device 30.

The setting value storage unit 206 stores a motor specification value, a measured value, a power consumption of the external equipment, and a parameter setting value. The motor specification value is, for example, a torque constant. The measured value is related to viscous friction, Coulomb friction, etc. The parameter setting value includes a speed, an acceleration, etc. The speed and the acceleration as the parameter setting values are changed by the setting change unit 208. The power consumption of the external equipment is obtained by calculating an operation time from an operation signal inputted from the external equipment and referring to a power consumption per unit time obtained from catalog specifications.

The expected power consumption calculation unit 207 acquires an actual power consumption from the actual power consumption acquisition unit 210, acquires, from the setting value storage unit 206, the speed and the acceleration obtained from the machining program (which serve as a first acceleration/deceleration setting), and acquires, from the setting value storage unit 206, a speed and an acceleration (which serve as a second acceleration/deceleration setting), which has been changed by the setting change unit 208. The expected power consumption calculation unit 207 calculates an expected power consumption based on the actual power consumption, the speed and the acceleration before the change (the first acceleration/deceleration setting), the speed and the acceleration after the change, (the second acceleration/deceleration setting). The method of calculating the expected power consumption will be described later. The acceleration includes both a case where the speed increases and a case where the speed decreases. The speed and the acceleration obtained from the machining program may be stored in the setting change unit 208. The expected power consumption calculation unit 207 can acquire the power consumption of the external equipment 50 from the setting value storage unit 206 and calculate the expected power consumption including the power consumption of the external equipment 50. In a case where the second acceleration/deceleration is further changed and an instruction for recalculation at the changed second acceleration/deceleration is outputted from the setting change unit 208, the expected power consumption calculation unit 207 recalculates the expected power consumption based on a speed, an acceleration and the like serving as the changed second acceleration/deceleration setting.

For example, the setting change unit 208 obtains the speed and the acceleration (first acceleration/deceleration setting) from the machining program stored in the program storage unit 201 and stores the speed and the acceleration in the setting value storage unit 206. The setting change unit 208 changes the speed and the acceleration obtained from the machining program and stores the changed speed and the changed acceleration (second acceleration/deceleration setting) in the setting value storage unit 206. The speed and the acceleration as the second acceleration/deceleration setting may be set by a user, or an amount of change may be preset based on the first acceleration/deceleration setting. The setting change unit 208 changes the acceleration/deceleration setting including the speed, the acceleration, and the like and serving as the second acceleration/deceleration setting, in accordance with a time constant and an expected power consumption designated by the user, and stores the changed speed and acceleration in the setting value storage unit 206. Furthermore, the setting change unit 208 sets an acceleration/deceleration time constant, a constant speed time, and the like for the acceleration/deceleration control unit 204 so that the designated expected power consumption is achieved. In the above description, the example in which the setting change unit 208 changes the speed and the acceleration has been described, but the acceleration/deceleration parameters to be changed depend on types of acceleration/deceleration. For example, in the case of linear acceleration/deceleration, which will be described later, a speed and an acceleration or a time constant at the time of acceleration/deceleration are/is changed. In the case of bell-shaped acceleration/deceleration, which will be described later, a primary acceleration/deceleration time and a secondary acceleration/deceleration time at the time of acceleration/deceleration or a time constant and a change in speed at the time of acceleration/deceleration are changed, for example. In the case of exponential acceleration/deceleration, which will be described later, a time constant and a finally-reachable speed at the time of acceleration/deceleration are changed, for example.

The FB acquisition unit 209 acquires a current detection value and a voltage detection value, or a current detection value and a speed detection value, which constitute feedback information from the servo control device 30. The feedback information from the servo control device 30 is acquired by operating the servo control device 30 based on the position command generated at the first acceleration/deceleration setting. The actual power consumption acquisition unit 210 calculates an actual power consumption based on the current detection value and the voltage detection value or the current detection value and the speed detection value, which are acquired by the FB acquisition unit 209. The actual power consumption acquisition unit 210 may acquire the actual power consumption using a wattmeter, and in this case, the FB acquisition unit 209 may be omitted.

The display setting unit 211 makes display setting for the display unit 212 such that the actual power consumption acquired by the actual power consumption acquisition unit 210 and the expected power consumption calculated by the expected power consumption calculation unit 207 are displayed for each set period. The display unit 212 displays the actual power consumption and the expected power consumption on a display screen based on the display setting made by the display setting unit 211. Details of the configuration of the display setting unit 211 and examples displayed by the display unit 212 will be described later.

The user can change the value of the expected power consumption with reference to the expected power consumption displayed on the display unit 212. As will be described later, in a case where the time constant and the like is displayed on the display screen, the user can change the value of the expected power consumption by changing the time constant and the like.

In the numerical control device 20 described above, the actual power consumption acquisition unit 210 acquires an actual power consumption based on the first acceleration/deceleration setting, and the expected power consumption calculation unit 207 calculates an expected power consumption based on the second acceleration/deceleration setting. The display unit 212 displays the actual power consumption and the expected power consumption. In response to the user changing the time constant and the like or the expected power consumption with reference to the display screen of the display unit 212, the setting change unit 208 changes the second acceleration/deceleration setting such as the speed and the acceleration, and stores the changed speed, the changed acceleration, and the like in the setting value storage unit 206. Hereinafter, these operations will be described in more detail.

First, an actual power consumption acquisition method that is performed by the actual power consumption acquisition unit 210 will be described.

### Actual Power Consumption Acquisition Method

The actual power consumption acquisition unit 210 can acquire the actual power consumption P by calculation according to Expression 1 (Exp. 1 described below). In Expression 1, Iq represents a detection current that is current feedback, V represents a detection voltage, and ω represents an angular velocity. The detection current Iq and the detection voltage V are outputted from the servo control device 30. The angular velocity ω can be calculated from a speed detection value as speed feedback described later. The actual power consumption P can be calculated based on the detection current Iq and the detection voltage V, or the detection current Iq and the angular velocity ω.

$$P = \sqrt{3} \times Iq \times V = \frac{Kt \times Iq \times ω}{60} \qquad [ Exp . 1 ]$$

Alternatively, the actual power consumption acquisition unit 210 can acquire, using a wattmeter, an actually measured value as the actual power consumption P.

Next, an expected power consumption calculation method that is performed by the expected power consumption calculation unit 207 will be described.

### Expected Power Consumption Calculation Method

An overall expected power consumption Pe in a case where a machining program describes that an acceleration/deceleration operation is performed n times (n is a natural number) is expressed by Expression 2 (Exp. 2 described below). In Expression 2, Pa represents an expected power consumption of the servo control device at a certain clock time, time T represents a time period from a start position to a target position, Tx represents an expected operation time period of the machine, and A represents a power consumption of the external equipment 50 at the certain clock time. Here, the expected power consumption calculation unit 207 calculates the power consumption of the external equipment 50 within the time period Tx, but it is not essential to calculate the power consumption of the external equipment 50.

$$Pe = {\int }_{0}^{T} Pa dt + … + {\int }_{0}^{Tx} A dt \qquad [ Exp . 2 ]$$

The expression of the first term of Expression 2 indicates the integral of the expected power consumption Pa within the time period T, and the expression of the last term of Expression 2 indicates the integral of the expected power consumption A of the external equipment 50 in the expected operation time period Tx of the machine. The acceleration/deceleration operation performed within the time period T is repeated n times within the expected operation time period Tx. In a case where the same acceleration/deceleration operation is repeated n times, Expression 2 includes n expressions of the first term. The expected power consumption Pa of the first term of Expression 2 is given in the following way: a power consumption increment/decrement corresponding to a change in acceleration/deceleration resulting when the acceleration/deceleration specified in the machining program is changed (when the first acceleration/deceleration setting is changed to the second acceleration/deceleration setting) is calculated, and the power consumption increment/decrement is added to or subtracted or from the actual power consumption P. The acceleration/deceleration setting for calculation of the actual power consumption corresponds to the first acceleration/deceleration setting. For example, when an expected power consumption at the first acceleration/deceleration setting before the change at a certain clock time is defined as Px1, an expected power consumption at the second acceleration/deceleration setting after the change is defined as Px2, and an actual power consumption is defined as P, the expected power consumption Pa of the first term of Expression 2 at the certain clock time can be calculated according to: Pa=(Px2−Px1)+P.

The first term of Expression 2 is an integral of the expected power consumptions Pa within the time period T, and indicates an expected power consumption in the first acceleration/deceleration operation described in the machining program.

Here, when a power consumption at a set acceleration/deceleration is defined as Px, the power consumption Px can be calculated by inserting Expression 3 (Exp. 3 described below) into Expression 4 (Exp. 4 described below). In Expressions 3 and 4, Kt represents a torque constant, Iqa represents a current, Jm represents inertia, F represents viscous friction or Coulomb friction, and ω represents an angular velocity.

$$Kt \times Iqa = Jm \times ( d ω / dt ) + F \times ω \qquad [ Exp . 3 ]$$

$$Px = \frac{Kt \times Iqa \times ω}{60} \qquad [ Exp . 4 ]$$

The inertia Jm and the friction F, which is the viscous friction and the Coulomb friction, are measured in advance and stored in the setting value storage unit 206. The angular velocity ω and an angular acceleration dω/dt are obtained from the machining program stored in the program storage unit 201 or are obtained based on the speed and the acceleration stored in the setting value storage unit 206. A power consumption Px calculated using the angular velocity ω and the angular acceleration dω/dt before the change, which are obtained from the machining program, is the power consumption Px1 described above. A power consumption Px calculated based on the angular velocity ω and the angular acceleration dω/dt obtained from the speed and the acceleration after the change, which are stored in the setting value storage unit 206, is the power consumption Px2 described above.

Hereinafter, a method of calculating an integral of the expected power consumptions Pe of Expression 2 within the time period T will be described with reference to a specific example.

### Linear Acceleration/Deceleration

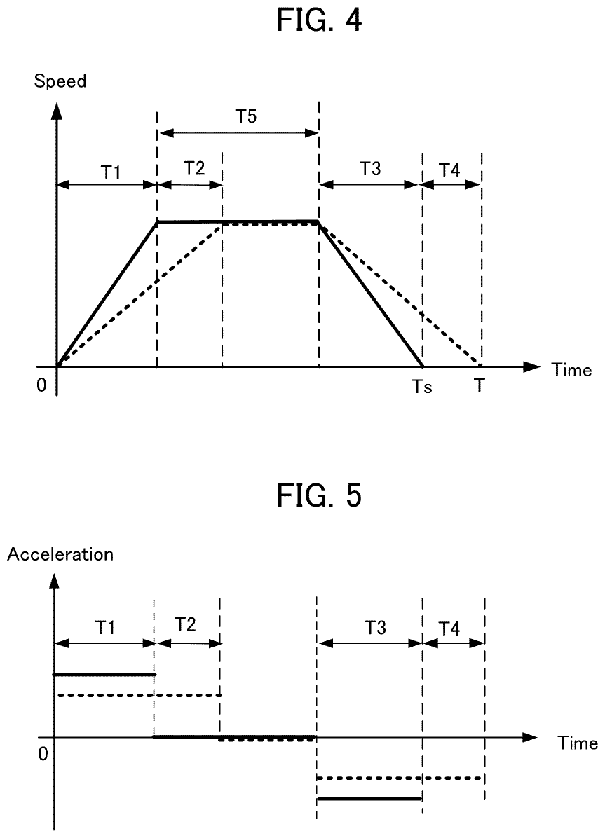

An example will be described in which, in a case where the machine tool operates with linear acceleration/deceleration, a time until arrival at a position increases due to a change in acceleration/deceleration. In the case of the linear acceleration/deceleration, an expected power consumption is calculated by changing a change in speed or a time constant. FIG. 4 is a characteristic diagram illustrating a change in speed over time before and after a change in acceleration/deceleration in the case of the linear acceleration/deceleration. FIG. 5 is a characteristic diagram illustrating a change in acceleration over time before and after the change in acceleration/deceleration in the case of the linear acceleration/deceleration.

In FIG. 4, the solid line represents the change in speed before the change in acceleration/deceleration, and the broken line represents the change in speed after the change in acceleration/deceleration. In FIG. 5, the solid line represents the change in acceleration before the change in acceleration/deceleration, and the broken line represents the change in acceleration after the change in acceleration/deceleration. In FIGS. 4 and 5, time T1 represents an acceleration period before the change in acceleration/deceleration, time T2 represents a period corresponding to a difference between constant speed periods before and after the change in acceleration/deceleration, time T3 represents a deceleration period before the change in acceleration/deceleration, and time T4 represents a period corresponding to a difference between deceleration periods before and after the change in acceleration/deceleration. Time T5 represents a constant speed period before the change in acceleration/deceleration. In FIG. 4, time T represents a time from the start position to the target position after the change in acceleration/deceleration, and time Ts represents a time from the start position to the target position before the change in acceleration/deceleration.

As illustrated in FIG. 4, a comparison between the speeds before and after the change in acceleration/deceleration demonstrates that the acceleration period becomes longer after the change than before the change, the constant speed period becomes shorter after the change than before the change, the deceleration period becomes longer after the change than before the change. The integral of the expected power consumptions Pa of the first term of Expression 2 and the power of the external equipment 50, which constitute the expected power consumption within the time T, can be calculated according to Expression 5 (Exp. 5 described below).

$$( Expected power consumption in time T ) = ( Actual power consumption in time Ts ) + ( Power consumption of external equipment in time T 4 ) - ( Expected power consumption at constant speed in time T 2 ) + ( ( Expected power consumption in acceleration / deceleration periods after change in acceleration / deceleration ) - ( Expected power consumption in acceleration / deceleration periods before change in acceleration / deceleration ) ) \qquad [ Exp . 5 ]$$

In Expression 5, the expected power consumption in acceleration/deceleration periods after the change in acceleration/deceleration refers to the expected power consumption in the acceleration period (T1+T2) and the deceleration period (T3+T4) as illustrated in FIG. 4, and the expected power consumption in the acceleration/deceleration periods before the change in acceleration/deceleration refers to the expected power consumption in the acceleration period T1 and the deceleration period T3 as illustrated in FIG. 4. In Expression 5, (Power at constant speed in time T2) and ((Expected power consumption in acceleration/deceleration periods after change in acceleration/deceleration)-(Expected power consumption in acceleration/deceleration periods before change in acceleration/deceleration)) do not include power of the external equipment. In Expression 5, (Actual power consumption in time Ts) includes the power consumption of the external equipment. A change in acceleration/deceleration causes not only a change in the acceleration/deceleration time, but also a change in a moving distance during the acceleration/deceleration, and accordingly, the constant speed time also changes. Expression 5 is an equation according to which an increment/decrement is calculated in consideration of these two factors.

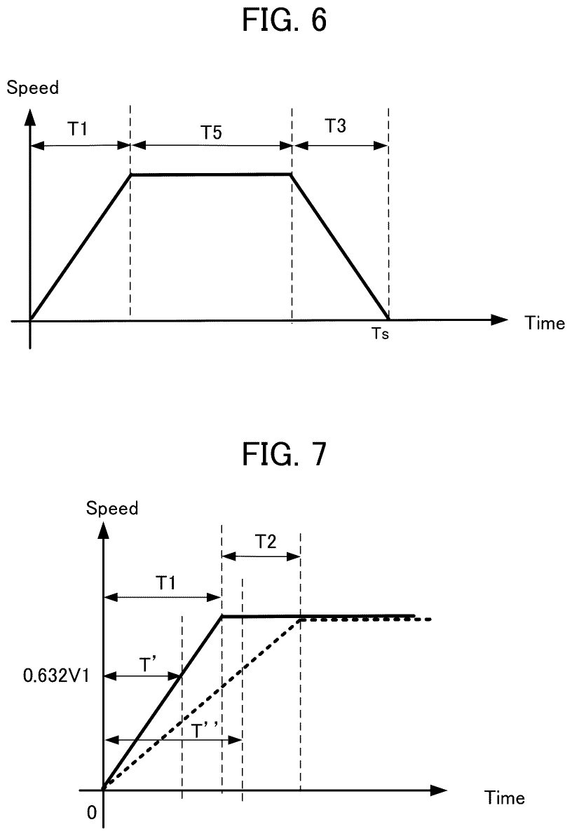

The power consumption at the constant speed before acceleration/deceleration, which does not include the power consumption of the external equipment, is obtained as follows. This can be calculated according to Expression 6 (Exp. 6 described below). FIG. 6 is a characteristic diagram illustrating a change in speed over time before the change in acceleration/deceleration. In FIG. 6, similarly to FIG. 4, time T1 represents an acceleration period before the change in acceleration/deceleration, time T3 represents a deceleration period before the change in acceleration/deceleration, and time T5 represents a constant speed period before the change in acceleration/deceleration. The power consumption in the time period T5, which does not include the power consumption of the external equipment, can be calculated according to Expression 6 (Exp. 6 described below). In Expression 6, (Actual power consumption until the end of time period Ts) includes the power consumption of the external equipment, whereas (Power consumption in acceleration/deceleration periods of time (T1+T5)) does not include the power consumption of the external equipment.

$$Expected power consumption at constant speed = ( Actual power consumption until end of time period Ts ) - ( Expected power consumption in acceleration / deceleration periods of time ( T 1 + T 5 ) ) - ( Power consumption of external equipment until end of time period Ts ) \qquad [ Exp . 6 ]$$

A specific calculation formula is described as Expression 7 (Exp. 7 below).

$$Expected power consumption at constant speed = {\int }_{0}^{Ts} \sqrt{3} \times It + Vt dt - {\int }_{0}^{T 1} \frac{Kt \times Iq \times ω}{60} dt - {\int }_{0}^{T 3} \frac{Kt \times Iq \times ω}{60} dt - {\int }_{0}^{Ts} A dt \qquad [ Exp . 7 ]$$

The expected power consumption at the constant speed may be calculated by extracting, from the acquired actual power consumption, only a portion corresponding to the constant speed, and converting the resulting value in terms of an expected constant speed time. Specifically, a value per unit time (e.g., per second) may be calculated for the portion corresponding to the constant speed in the actual power consumption, and then, multiplied by the expected constant speed time.

In the case of the linear acceleration/deceleration, the time periods T1, T2, T3, T4, and T5 and a distance Z to the target position can be calculated according to Expression 8 (Exp. 8 described below). In Expression 8, v1 represents a finally-reachable speed, a1 represents an acceleration before the change in acceleration/deceleration, and a2 represents an acceleration after the change in acceleration/deceleration. The finally-reachable speed v1 remains unchanged before and after the change in acceleration/deceleration.

$$T 1 = \frac{v 1}{a 1} , T 2 = \frac{v 1}{a 2} - T 1 , T 1 = T 3 , T 5 = Ts - 2 T 1 \qquad [ Exp . 8 ]$$

$$Z = \frac{T 1 \times v 1 \times 2}{2} + ( Ts - 2 T 1 ) v 1 = ( Ts - T 1 ) v 1 , Ts = \frac{Z}{v 1} - T 1$$

$$T4 = T 1 + T 2 - T 3 = T 2$$

In a case where a time constant is designated, the time periods T1 and T2 can be calculated using the time constant. By way of example, a case where the time periods T1 and T2 are calculated will be described. When a time constant at the time of acceleration before the change in acceleration/deceleration is defined as a time constant T′, and a time constant at the time of acceleration after the change in acceleration/deceleration is defined as a time constant T″, the time periods T1 and T2 can be calculated according to Expression 9 (Exp. 9 described below).

$$T 1 = \frac{{T}^{′}}{0.632} , {T}^{″} = 0.632 ( T 1 + T 2 ) , T 2 = \frac{{T}^{″} - {T}^{′}}{0.632} \qquad [ Exp . 9 ]$$

FIG. 7 is a characteristic diagram illustrating a change in speed over time at the time of acceleration before the change in acceleration/deceleration.

### Bell-Shaped Acceleration/Deceleration

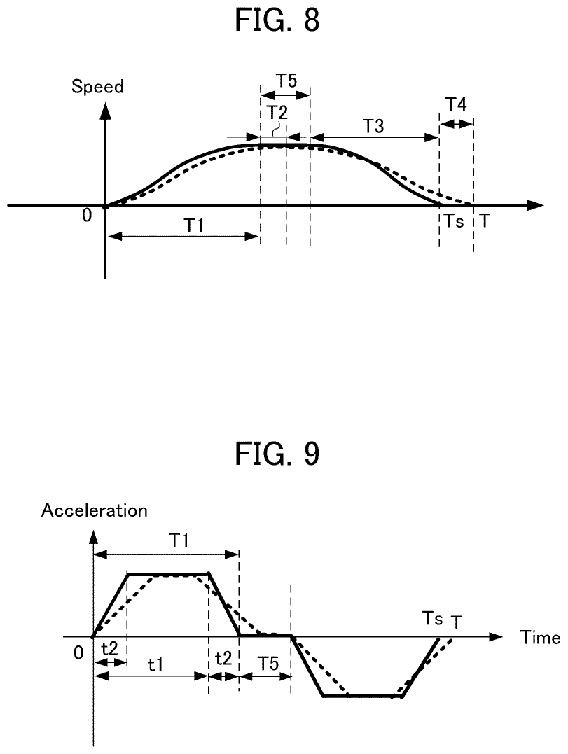

Hereinafter, an example will be described in which, in a case where the machine tool operates with bell-shaped acceleration/deceleration, a period of time until arrival at a position increases due to a change in acceleration/deceleration. In the case of the bell-shaped acceleration, an expected power consumption is calculated from a change in a primary acceleration/deceleration time t1 and a change in a secondary acceleration/deceleration time t2. An acceleration/deceleration setting after the change in acceleration/deceleration (second acceleration/deceleration setting) is obtained by changing the primary acceleration/deceleration time t1 and the secondary acceleration/deceleration time t2 at an acceleration/deceleration setting before the change in acceleration/deceleration (first acceleration/deceleration setting). FIG. 8 is a characteristic diagram illustrating a change in speed over time before and after a change in acceleration/deceleration in the case of the bell-shaped acceleration/deceleration. FIG. 9 is a characteristic diagram illustrating a change in acceleration over time before and after the change in acceleration/deceleration in the case of the bell-shaped acceleration/deceleration. In FIG. 8, the solid line represents the change in speed before the change in acceleration/deceleration, and the broken line represents the change in speed after the change in acceleration/deceleration. In FIG. 9, the solid line represents the change in acceleration before the change in acceleration/deceleration, and the broken line represents the change in acceleration after the change in acceleration/deceleration.

In FIGS. 8 and 9, time T1 represents an acceleration period before the change in acceleration/deceleration, time T2 represents a period corresponding to a difference between constant speed periods before and after the change in acceleration/deceleration, time T3 represents a deceleration period before the change in acceleration/deceleration, and time T4 represents a period corresponding to a difference between deceleration periods before and after the change in acceleration/deceleration. Time T5 represents a constant speed period before the change in acceleration/deceleration. As illustrated in FIG. 8, a comparison between the speeds before and after the change in acceleration/deceleration demonstrates that the acceleration period becomes longer after the change than before the change, the constant speed period becomes shorter after the change than before the change, the deceleration period becomes longer after the change than before the change. The integral of the expected power consumptions Pa of the first term of Expression 2 and the power of the external equipment within the time T can be calculated according to Expression 10 (Exp. 10 described below).

$$Expected power consumption = ( Actual power consumption ) + ( Power consumption of external equipment in time T 4 ) - ( Expected power consumption at constant speed in time ( T 5 - T 2 ) ) + ( ( Expected power consumption in acceleration / deceleration periods after change in acceleration / deceleration ) - ( Expected power consumption in acceleration / deceleration periods before change in acceleration / deceleration ) ) \qquad [ Exp . 10 ]$$

In Expression 10, the expected power consumption in the acceleration/deceleration periods after the change in acceleration/deceleration refers to the expected power consumption in the acceleration period (T1+T2) and the deceleration period (T3+T4), and the expected power consumption in the acceleration/deceleration periods before the change in acceleration/deceleration refers to the expected power consumption in the acceleration period T1 and the deceleration period T3. In Expression 10, (Power at constant speed in time (T5−T2) and ((Expected power consumption in the acceleration/deceleration periods after the change in acceleration/deceleration)-(Expected power consumption in the acceleration/deceleration periods before the change in acceleration/deceleration)) do not include power of the external equipment. A change in acceleration/deceleration causes not only a change in the acceleration/deceleration time, but also a change in a moving distance during the acceleration/deceleration, and accordingly, the constant speed time also changes. Expression 10 is an equation according to which an increment/decrement is calculated in consideration of these two factors.

In the case of the bell-shaped acceleration/deceleration, the time periods T1, T2, T3, T4, and T5 and the distance Z to the target position can be calculated according to Expression 11 (Exp. 11 described below). In Expression 11, v1 represents a finally-reachable speed, and a1 represents an acceleration before the change in acceleration/deceleration. The finally-reachable speed v1 remains unchanged before and after the change in acceleration/deceleration. In Expression 11, τ1 represents a time constant before the change in acceleration/deceleration, τ2 represents a time constant after the change in acceleration/deceleration, t1 represents the primary acceleration/deceleration time before the change in acceleration/deceleration, t2 represents the secondary acceleration/deceleration time before the change in acceleration/deceleration, and T5 represents a constant speed time that is actually measured. T5−T2 represents an expected constant speed time.

$$T 1 = τ 1 , T 1 + T 2 = τ 1 , T 1 = T 3 , T 5 = T s - 2 T 1 \qquad [ Exp . 11 ]$$

$$T 1 + T 2 = T 3 + T 4 , T 2 = T 4 , v 1 = a 1 \times t 1$$

$$Z = ( {\int }_{0}^{t 2} \int \frac{a 1}{t 2} t {dt}^{2} + {\int }_{0}^{t 1 - t 2} \int a 1 {dt}^{2} + {\int }_{0}^{t 2} \int ( a 1 - \frac{a 1}{t 2} t ) d {t}^{2} ) \times 2 + ν1 ( T s - 2 T 1 ) = v 1 ( t 1 + t 2 ) + v 1 ( T s - 2 T 1 )$$

$$Ts = 2 T 1 + \frac{Z}{v 1} - ( t 1 + t 2 )$$

### Exponential Acceleration/Deceleration

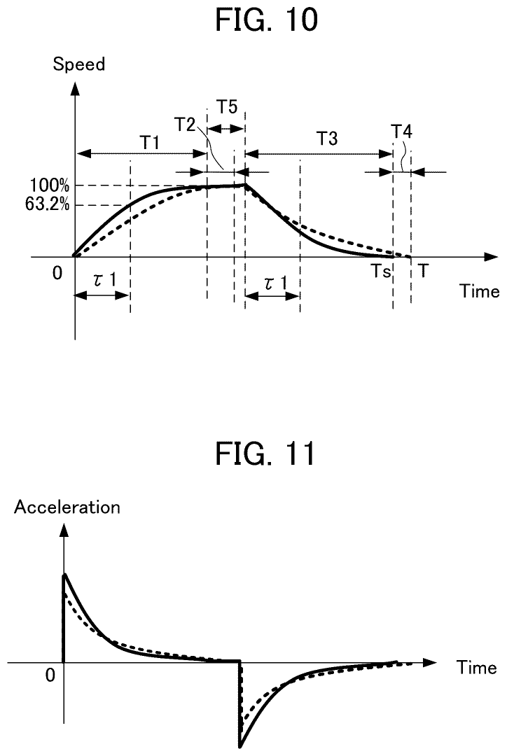

Hereinafter, an example will be described in which, in a case where the machine tool operates with exponential acceleration/deceleration, a period of time until arrival at a position increases due to a change in acceleration/deceleration. In the case of the exponential acceleration/deceleration, an expected power consumption is calculated based on a change in a time constant or a change in a reachable speed. An acceleration/deceleration setting after the change in acceleration/deceleration (second acceleration/deceleration setting) is obtained by changing the time constant and the finally-reachable speed at the time of acceleration/deceleration at an acceleration/deceleration setting before the change in acceleration/deceleration (first acceleration/deceleration setting). FIG. 10 is a characteristic diagram illustrating a change in speed over time before and after the change in acceleration/deceleration in the case of the exponential acceleration/deceleration. FIG. 11 is a characteristic diagram illustrating a change in acceleration over time before and after the change in acceleration/deceleration in the case of the exponential acceleration/deceleration.

In FIG. 10, the solid line represents the change in speed before the change in acceleration/deceleration, and the broken line represents the change in speed after the change in acceleration/deceleration. In FIG. 11, the solid line represents the change in acceleration before the change in acceleration/deceleration, and the broken line represents the change in acceleration after the change in acceleration/deceleration. In FIG. 10, time T1 represents an acceleration period before the change in acceleration/deceleration, time T2 represents a period corresponding to a difference between constant speed periods before and after the change in acceleration/deceleration, time T3 represents a deceleration period before the change in acceleration/deceleration, and time T4 represents a period corresponding to a difference between deceleration periods before and after the change in acceleration/deceleration. Time T5 represents a constant speed period before the change in acceleration/deceleration.

As illustrated in FIG. 10, a comparison between the speeds before and after the change in acceleration/deceleration demonstrates that the acceleration period becomes longer after the change than before the change, the constant speed period becomes shorter after the change than before the change, the deceleration period becomes longer after the change than before the change. The integral of the expected power consumptions Pa of the first term of Expression 2 and the power of the external equipment within the time T can be calculated according to Expression 12 (Exp. 12 described below).

$$Expected power consumption = ( Actual power consumption ) + ( Power consumption of external equipment in time T 4 ) - ( Power consumption at constant speed in time T 2 ) + ( ( Expected power consumption in acceleration / deceleration periods after change in acceleration / deceleration ) - ( Expected power consumption in acceleration / deceleration periods before change in acceleration / deceleration ) ) \qquad [ Exp . 12 ]$$

In Expression 12, the expected power consumption in the acceleration/deceleration periods after the change in acceleration/deceleration refers to the expected power consumption in the acceleration period (T1+T2) and the deceleration period (T3+T4), and the expected power consumption in the acceleration/deceleration periods before the change in acceleration/deceleration refers to the expected power consumption in the acceleration period T1 and the deceleration period T3. In Expression 12, (Power consumption at constant speed in time T2) and ((Expected power consumption in acceleration/deceleration periods after change in acceleration/deceleration)-(Expected power consumption in acceleration/deceleration periods before change in acceleration/deceleration)) do not include power of the external equipment. A change in acceleration/deceleration causes not only a change in the acceleration/deceleration time, but also a change in a moving distance during acceleration/deceleration, and accordingly, the constant speed time also changes. Expression 12 is an equation according to which an increment/decrement is calculated in consideration of these two factors.

In the case of the exponential acceleration/deceleration, the time periods T1, T2, T3, T4, and T5 and the distance Z to the target position can be calculated according to Expression 13 (Exp. 13 described below) and Expression 14 (Exp. 14 described below). In Expressions 13 and 14, v1 represents a finally-reachable speed, τ1 represents a time constant before the change in acceleration/deceleration, τ2 represents a time constant after the changes in acceleration/deceleration change, V1(t) represents a speed at the time of acceleration, and V′1(t) represents a speed at the time of deceleration. In the case of the exponential, since it is difficult to obtain the time period T1 with accuracy, the time until a clock time at which the speed feedback reaches v1 is defined as the time period T1.

$$T 1 = T 3 , V 1 ( t ) = v 1 ( 1 - {e}^{\frac{- t}{τ 1}} ) , V {1}^{′} ( t ) = v 1 {e}^{\frac{- ( t - T 1 - T 5 )}{τ 1}} \qquad [ Exp . 13 ]$$

$$Z = {\int }_{0}^{T 1} V 1 ( t ) dt + v 1 T 5 + {\int }_{T 1 + T 5}^{T s} {V}^{′} ( t ) dt = v 1 T 1 + v 1 T 5$$

$$T 5 = \frac{Z}{v 1} - T 1 , T s = T 1 + T 5 + T 3$$

Likewise, time Ts may be an actually measured time taken until arrival at the target position. Under the precondition that V1(T1)=V2(T1+T2), the time period T2 is expressed by Expression 14 (Exp. 14 described below).

$$V 2 ( t ) = v 1 ( 1 - {e}^{\frac{- t}{τ 2}} ) , T 2 = T 1 τ 2 ( \frac{1}{τ 1} - \frac{1}{τ 2} ) , T 4 = T 2 \qquad [ Exp . 14 ]$$

In the foregoing, the examples in which the period of time until arrival at a position increases due to a change in acceleration/deceleration in the linear acceleration/deceleration, the bell-shaped acceleration/deceleration, and the exponential acceleration/deceleration have been described. However, the present embodiment is also applicable to an example in which a period of time until the arrival at a position decreases due to a change in acceleration/deceleration. In such a case, the signs are reversed in the second and third terms of Expressions 5, 10, and 12, which are computational expressions for calculating the expected power consumption.

Next, details of the configuration of the display setting unit 211 and examples displayed by the display unit 212 will be described.

### Configuration of Display Setting Unit and Examples Displayed by Display Unit

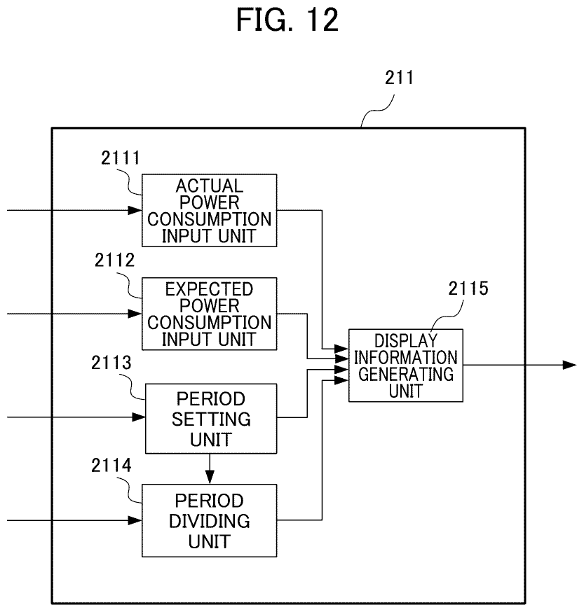

FIG. 12 is a block diagram illustrating a configuration example of the display setting unit. As illustrated in FIG. 12, the display setting unit 211 includes an actual power consumption input unit 2111, an expected power consumption input unit 2112, a period setting unit 2113, a period dividing unit 2114, and a display information generating unit 2115.

The actual power consumption input unit 2111 received an input of an actual power consumption from the actual power consumption acquisition unit 210, and outputs the actual power consumption to the display information generating unit 2115. The expected power consumption input unit 2112 receives an input of an expected power consumption from the expected power consumption calculation unit 207, and outputs the expected power consumption to the display information generating unit 2115.

The period setting unit 2113 outputs a setting period set by the user to the display information generating unit 2115 as period setting information. The period setting unit 2113 stores the setting period. Although the user sets the setting period here, the setting period may be set in advance. In a case where a setting period division instruction is given by the user, the period dividing unit 2114 reads the setting period from the period setting unit 2113, divides the setting period, and outputs a plurality of divided setting periods to the display information generating unit 2115 as period setting information. The display information generating unit 2115 stores the actual power consumptions inputted from the actual power consumption input unit 2111 in chronological order, and stores the expected power consumptions inputted from the expected power consumption input unit 2112 in chronological order. The display information generating unit 2115 reads the actual power consumptions and the expected power consumptions within the setting period set by the period setting unit 2113 and graphs the power consumptions. The display information generating unit 2115 then outputs display information for the display unit 212 to display the graph on the screen. In a case where there are a plurality of expected power consumptions calculated at a plurality of acceleration/deceleration settings or calculated at acceleration/deceleration settings before and after a change, the plurality of expected power consumptions and the actual power consumption may be displayed in one graph, or may be displayed by providing a plurality of graphs each displaying one expected power consumption and the actual power consumption.

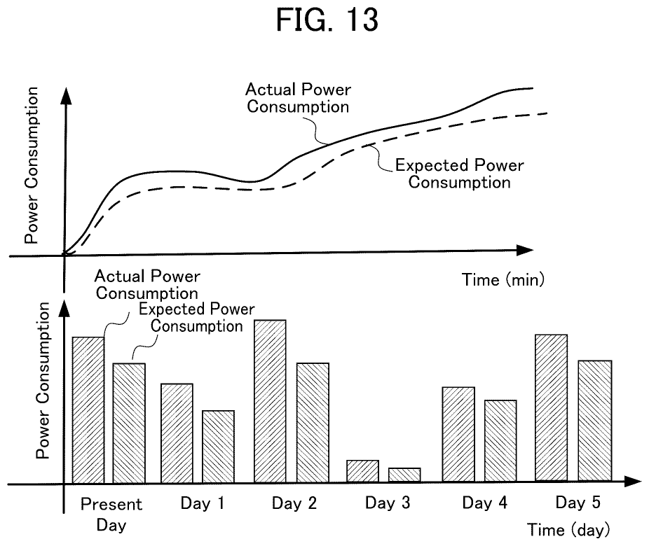

Hereinafter, examples displayed by the display unit 212 will be described. FIG. 13 is a diagram illustrating a first example of a graphical display on the display unit. FIG. 13 illustrates a graph (upper graph) showing a change in the actual power consumption over time and a change in the expected power consumption over time from the start of operation of the machine, and a graph (lower graph) showing daily changes in the actual power consumption and the expected power consumption. In the lower graph in FIG. 13, the actual power consumptions and the expected power consumptions of day 1 to day 5 subsequent to the present day are future data predicted from the trend of data of the past actual power consumptions and the past expected power consumptions on the basis of the actual power consumption and the expected power consumption of the present day. In order to display the contents illustrated in FIG. 13 on the display unit 212, the user inputs, to the period setting unit 2113 of the display setting unit 211, a time and a day for which the actual power consumption and the expected power consumption are to be displayed in a graph. In a case where the operation time or the number of operation cycles for the machining program differs depending on the day, the display unit 212 can additionally display the operation time or the number of operation cycles for the machining program. In a case where the setting period is divided by the period dividing unit 2114, one or both of the upper and lower graphs in FIG. 13 may be divided into a plurality of graphs and displayed.

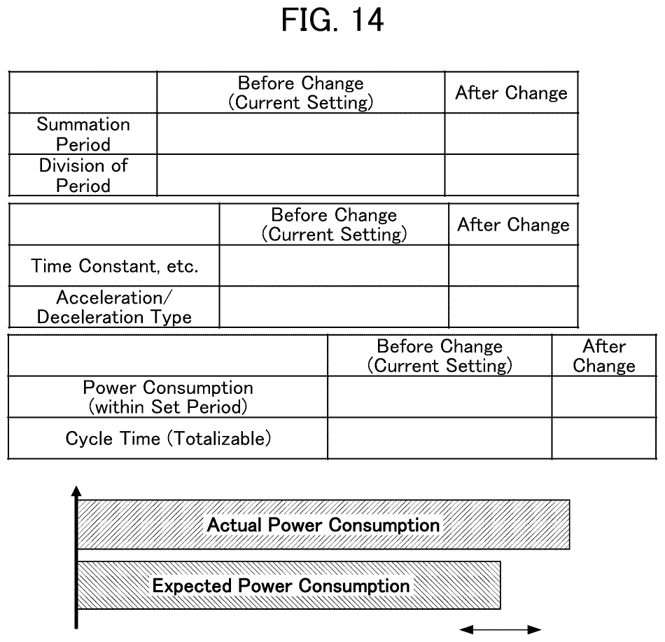

FIG. 14 is a diagram illustrating a second example of a graphical display on the display unit. FIG. 14 illustrates a table showing a totalization period, division of period, a time constant, an acceleration type, a power consumption, a cycle time, and the like, and a graph showing an actual power consumption (at the current setting) and an expected power consumption. The user sets the totalization period and the division of period by way of input to the display setting unit 211. For example, the period is arbitrarily set to Monday to Friday, Monday to Saturday, or Monday to Sunday. The period may be divided into a period from Monday to Friday and a period from Saturday to Sunday. The time constant and the acceleration/deceleration type (the linear acceleration/deceleration, the bell-shaped acceleration/deceleration, or the exponential acceleration/deceleration) are set by the display information generating unit 2115, which obtains them from the machining program or reads them from the setting value storage unit 206. The time constant and the acceleration/deceleration type can also be set by the user via the display screen. The power consumption and the cycle time are calculated by the expected power consumption calculation unit 207 and inputted to the display information generating unit 2115 of the display setting unit 211. The power consumption (expected power consumption) and the cycle time may be calculated by the display information generating unit 2115. The display information generating unit 2115 may display an electricity rate instead of the cycle time or may display both the cycle time and the electricity rate on the display unit 212 according to the designation by the user. The cycle time (the operation time of an axis) can be obtained, for example, from the time T shown in FIGS. 4, 6, and 10. When a plurality of axes are to be moved at the same time, the longest operation time is defined as the cycle time. A wait time such as a dwell time may also be added to the cycle time. The operation time of the spindle is determined from a designated rotation time. The table and the graph illustrated in FIG. 14 can be linked with each other. For example, the graph indicates the actual power consumption and the expected power consumption after the change, and in response to the user changing the value of the power consumption (expected power consumption) in the table, the length of the graph of the expected power consumption changes. A configuration is conceivable in which the user directly changes the length of the graph of the expected power consumption.

Hereinafter, it will be described how the setting change unit 208 changes the acceleration/deceleration settings. In a case where the user inputs a time constant and an acceleration/deceleration type, the setting change unit 208 outputs the time constant and the acceleration/deceleration type to the expected power consumption calculation unit 207. The expected power consumption calculation unit 207 calculates an expected power consumption from the time constant in accordance with the acceleration/deceleration type. In a case where the user inputs an expected power consumption, the expected power consumption calculation unit performs reverse calculation to determine how the acceleration/deceleration needs to be changed in order to achieve the target expected power consumption. A change in the time constant or the acceleration/deceleration causes a change in the acceleration/deceleration time and a change in the constant speed time at the same time. Since the power at the constant speed is obtained from the actual measurement value, an optimum value is calculated in consideration of a change in the power of the external equipment due to the increase/decrease in the acceleration/deceleration time and the increase/decrease in the constant speed time. In a case where the expected power consumption is to be changed, the acceleration/deceleration may be changed by increasing or decreasing all of acceleration/deceleration time constants at the same rate, or the acceleration/deceleration may be individually set. The range of change in the expected power consumption is set to a range of change that can be caused by increasing and decreasing the acceleration/deceleration. In a case where the acceleration/deceleration type is the linear acceleration/deceleration, the setting change unit 208 changes, for example, the time constant at the time of acceleration/deceleration. In a case where the acceleration/deceleration type is the bell-shaped acceleration/deceleration, the setting change unit 208 changes, for example, the primary acceleration/deceleration time and the secondary acceleration/deceleration time at the time of acceleration/deceleration, or the time constant and the change in speed at the time of acceleration/deceleration. In a case where the acceleration/deceleration type is the exponential acceleration/deceleration, the setting change unit 208 changes the time constant and the finally-reachable speed at the time of acceleration/deceleration.

### External Equipment

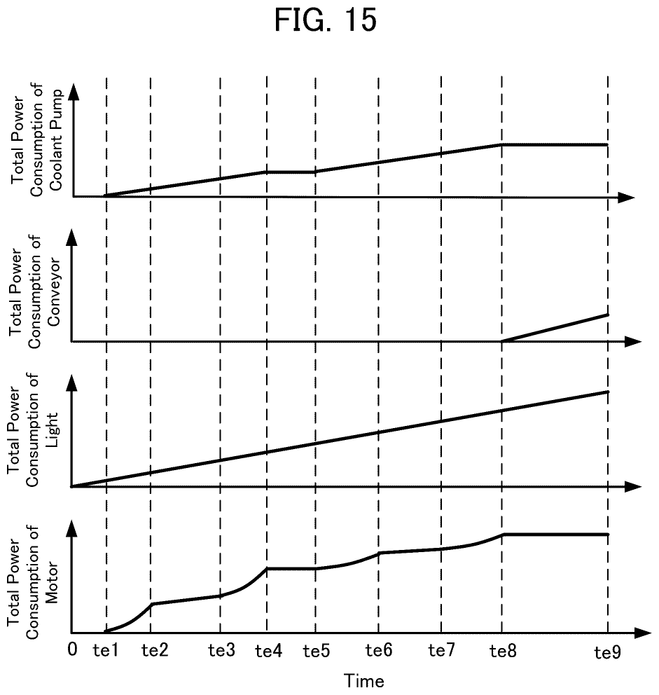

As described above, the external equipment 50 includes the coolant pump for circulating a coolant, the conveyor for collecting chips and the like, a light, etc. The external equipment may include a vibration meter, a camera, and a brake device. As described above, the power consumption of the external equipment 50 is calculated based on the operation time of the external equipment 50 and the power consumption per unit time obtained from the catalog specifications. FIG. 15 is a characteristic diagram illustrating a total power consumption of the coolant pump, a total power consumption of the conveyor, and a total power consumption of the light in comparison with a total power consumption of the motor. In FIG. 15, a period from 0 to te1 is a waiting time (dwell) of the motor, a period from te1 to te2 is an acceleration time, a period from te2 to te3 is a constant speed time, a period from te3 to te4 is a deceleration time, a period from te4 to te5 is a waiting time (dwell) of the motor, a period from te5 to te6 is an acceleration time, a period from te6 to te7 is a constant speed time, a period from te7 to te8 is a deceleration time, and a period from te8 to te9 is a waiting time (dwell) of the motor. As illustrated in FIG. 15, the coolant pump operates in conjunction with the operation of the motor, and the coolant pump does not consume power during each waiting time of the motor. The light and the conveyor for collecting chips and the like operate irrespective of the operation of the motor. The conveyor operates when the amount of chips reaches a certain value, whereby the conveyor consumes power. The light is lit before the motor is operated, whereby the light consumes power.

The numerical control device of the present embodiment described above performs calculation based on an actual power consumption and a power consumption increment/decrement resulting from a change in acceleration/deceleration, thereby making it possible to calculate an expected power consumption that is more accurate than a simple expected value. In addition, the numerical control device of the present embodiment can assist the user in making the setting, by visualizing the actually measured power and the expected power consumption in the form of a graph.

In the foregoing, the functional blocks included in the numerical control device 20 and those included in the servo control device 30 have been described. In order to realize these functional blocks, each of the numerical control device 20 and the servo control device 30 includes an arithmetic processing device such as a central processing unit (CPU). Each of the numerical control device 20 and the servo control device 30 further includes an auxiliary storage device such as a hard disk drive (HDD) that stores various control programs such as application software or an operating system (OS), and a main storage device such as a random access memory (RAM) that temporarily stores data required when the arithmetic processing device executes a program.

In each of the numerical control device 20 and the servo control device 30, the arithmetic processing device reads the application software or the OS from the auxiliary storage device, and performs arithmetic processing based on the application software or the OS while expanding the read application software or OS in the main storage device. Furthermore, the arithmetic processing device controls various kinds of hardware included in each device, based on the results of the arithmetic processing. In this way, the functional blocks of the present embodiment are realized. In other words, the present embodiment can be implemented by way of cooperation between hardware and software.

The numerical control device 20 may include the servo control device 30, and in this case, the arithmetic processing device such as the central processing unit (CPU), the auxiliary storage device, and the main storage device are shared, and the numerical control device 300 and the servo control device 400 do not have to be provided with their own CPU and memories.

In a case where the numerical control device 20 or the servo control device 30 needs to perform a large amount of arithmetic processing, for example, graphics processing units (GPUs) are mounted in a personal computer, and a technique called general-purpose computing on graphics processing units (GPGPU) is employed to use the GPUs for arithmetic processing accompanying machine learning, thereby making it possible to perform high-speed processing. Furthermore, in order to perform the higher-speed processing, a computer cluster including a plurality of computers equipped with such GPUs may be constructed, and parallel processing may be performed by the plurality of computers included in the computer cluster.

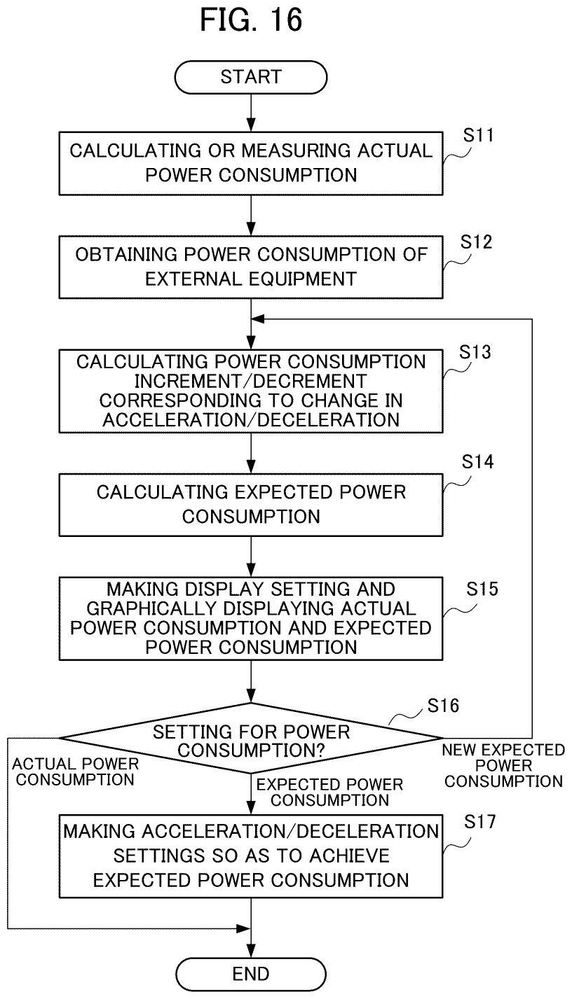

Next, an operation of the numerical control device 20 according to the present embodiment will be described with reference to the flowchart in FIG. 16. The flowchart in FIG. 16 illustrates the operation of the numerical control device 20 according to the present embodiment.

First, in Step S11 in FIG. 16, the actual power consumption acquisition unit 210 acquires a detection current value and a detection voltage value from the FB acquisition unit 209, and calculates an actual power consumption. In Step S12, the expected power consumption calculation unit 207 acquires an operation time of the external equipment 50, and calculates a power consumption of the external equipment 50 based on a power consumption per unit time obtained from the catalog specifications.

In Step S13, a power consumption increment/decrement corresponding to a change in acceleration/deceleration is calculated. Specifically, the expected power consumption calculation unit 207 reads the inertia Jm and the friction F, which is the viscous friction and the Coulomb friction, from the setting value storage unit 206, and obtains an angular velocity ω and an angular acceleration dω/dt from a machining program stored in the program storage unit 201 or from a speed and an acceleration stored in the setting value storage unit 206. Furthermore, the expected power consumption calculation unit 207 acquires the change in acceleration/deceleration from the setting change unit 208. The expected power consumption calculation unit 207 then calculates the power consumption increment/decrement corresponding to the change in acceleration/deceleration, in accordance with Expression 4 in which Expression 3 is inserted. In Step S14, the expected power consumption calculation unit 207 calculates an expected power consumption by adding the actual power consumption, the power consumption increment/decrement corresponding to the change in acceleration/deceleration, and the power consumption of the external equipment 50.

In Step S15, the display setting unit 211 makes a display setting for the display unit 212 such that the actual power consumption acquired by the actual power consumption acquisition unit 210 and the expected power consumption calculated by the expected power consumption calculation unit 207 are displayed for each set period, and the display unit 212 graphically displays the actual power consumption and the expected power consumption.

The user who views the display screen of the display unit 212 determines whether to select the current power consumption (actual power consumption), the expected power consumption, or recalculation of a new expected power consumption.

When the user viewing the display screen of the display unit 212 inputs a change in acceleration/deceleration or a change in power consumption to the setting change unit 208 in Step S16 for the purpose of recalculation of a new expected power consumption, the setting change unit 208 determines that setting value of the acceleration/deceleration is to be changed (“new power consumption” in Step S16). The setting change unit 208 then instructs the expected power consumption calculation unit 207 to recalculate the expected power consumption, stores the value of a change in speed, the value of a change in speed, acceleration, and the like in the setting value storage unit 206, and returns to Step S13. In Steps S13 and S14, the expected power consumption is recalculated. When the user inputs the expected power consumption to the setting change unit 208 in Step 16, the process proceeds to Step S17. In Step 17, the setting change unit 208 changes the acceleration/deceleration of the acceleration/deceleration control unit 204 so as to achieve the expected power consumption, and ends the process. When the user inputs the actual power consumption to the setting change unit 208 in Step 16, since no change is to be made to the acceleration/deceleration, the process ends.

Each of the constituent units included in the numerical control device 10 can be implemented by hardware, software, or a combination thereof. The method of adjusting the control parameters performed by the cooperation between the constituent units included in the numerical control device 10 can also be implemented by hardware, software, or a combination thereof. Here, the implementation by software means that a computer reads and executes a program for the implementation.

The program can be stored in various types of non-transitory computer readable media and can be provided to a computer. The non-transitory computer readable media include various types of tangible storage media. Examples of the non-transitory computer readable media include a magnetic recording medium (e.g., a hard disk drive), a magnetic-optical recording medium (e.g., a magnetic optical disk), a read only memory (CD-ROM), a CD-R, a CD-R/W, and a semiconductor memory (e.g., a mask ROM, a programmable ROM (PROM), an erasable PROM (EPROM), a flash ROM, and a random access memory (RAM)). The program may be provided to the computer by way of various types of transitory computer readable media.

Although the above-described embodiment is a preferred embodiment of the present invention, the scope of the present invention is not limited to the above-described embodiment. Various modifications can be made without deviating from the spirit of the present invention. For example, in the above-described embodiment, the numerical control machine tool that controls the machine tool by the numerical control device has been described, but the machine controlled by the numerical control device is not limited to the machine tool, and may be a robot or an industrial machine.

The numerical control device and the expected power consumption calculation method according to the present disclosure can be implemented in various embodiments having the following configurations, inclusive of the above-described embodiment.

(1) A numerical control device (e.g., the numerical control device 20) includes a program storage unit (e.g., the program storage unit 201) configured to store an operation program for operating a machine; an actual power consumption acquisition unit (e.g., the actual power consumption acquisition unit 210) configured to acquire an actual power consumption by calculation or actual measurement while the machine is operated at a first acceleration/deceleration setting that is based on the operation program; an expected power consumption calculation unit (e.g., the expected power consumption calculation unit 207) configured to calculate an expected power consumption by adding at least the actual power consumption and a power consumption increment/decrement corresponding to a change in acceleration/deceleration resulting from a change from the first acceleration/deceleration setting to a second acceleration/deceleration setting; a setting value storage unit (e.g., the setting value storage unit 206) configured to store at least a part of information necessary for the expected power consumption calculation unit to calculate a power consumption at the first acceleration/deceleration setting and a power consumption at the second acceleration/deceleration setting; and a display unit (e.g., the display unit 212) configured to display the actual power consumption and the expected power consumption. The numerical control device having the above-described configuration makes it possible to calculate an expected value of power consumption with improved accuracy. In addition, by visualizing the actual power consumption and the expected power consumption, the numerical control device can facilitate a comparison between the power consumptions and support reduction in the power consumption.

(2) The numerical control device described in (1) is connected to a servo control device (e.g., the servo control device 30) that operates the machine, and includes a feedback acquisition unit (e.g., the FB acquisition unit) configured to acquire, from the servo control device, feedback information including a detection voltage and a detection current or a detection current and a detection speed and the actual power consumption acquisition unit acquires the actual power consumption by calculation using the feedback information.

(3) The numerical control device described in (1) includes a display setting unit (e.g., the display setting unit 211) configured to make a display setting for the display unit to display the actual power consumption and the expected power consumption for each period set.

(4) In the numerical control device described in (3), the display setting unit includes a period setting unit (e.g., the period setting unit 2113) that sets the period and a period dividing unit (e.g., the period dividing unit 2114) that divides the period set by the period setting unit, and the display setting unit makes a display setting for the display unit to display the actual power consumption and the expected power consumption for each divided period.

(5) The numerical control device described in (1) includes a setting change unit (e.g., the setting change unit 208) configured to change the first acceleration/deceleration setting to the second acceleration/deceleration setting, and the setting change unit changes the second acceleration/deceleration setting, and the expected power consumption calculation unit recalculates the expected power consumption based on the second acceleration/deceleration setting changed by the setting change unit.

(6) In the numerical control device described in (1), the expected power consumption calculation unit acquires a power consumption of external equipment from the setting value storage unit and calculates the expected power consumption including the power consumption of the external equipment.

(7) In the numerical control device described in any one of (1) to (6), the expected power consumption calculation unit calculates the expected power consumption by totalizing: the actual power consumption; an increment/decrement before and after a change from the first acceleration/deceleration setting to the second acceleration/deceleration setting, with respect to a power consumption at a constant speed; and an increment/decrement before and after the change from the first acceleration/deceleration setting to the second acceleration/deceleration setting, with respect to a power consumption at a time of acceleration/deceleration.

(8) In the numerical control device described in (7), the first and second acceleration/deceleration settings are set for linear acceleration/deceleration, the numerical control device includes a setting change unit (e.g., the setting change unit 208) configured to change the first acceleration/deceleration setting to the second acceleration/deceleration setting, and the setting change unit changes a time constant at the time of acceleration/deceleration.

(9) In the numerical control device described in (7), the first and second acceleration/deceleration settings are set for bell-shaped acceleration/deceleration, the numerical control device includes a setting change unit (e.g., the setting change unit 208) configured to change the first acceleration/deceleration setting to the second acceleration/deceleration setting, and the setting change unit changes a primary acceleration/deceleration time and a secondary acceleration/deceleration time at the time of acceleration/deceleration, or a time constant or a change in speed at the time of acceleration/deceleration.

(10) In the numerical control device described in (7), the first and second acceleration/deceleration settings are set for exponential acceleration/deceleration, the numerical control device includes a setting change unit (e.g., the setting change unit 208) configured to change the first acceleration/deceleration setting to the second acceleration/deceleration setting, and the setting change unit changes a time constant and a finally-reachable speed at the time of acceleration/deceleration.

(11) A method of calculating an expected power consumption by a computer that functions as a numerical control device and includes a program storage unit storing an operation program for operating a machine, the method causing the computer to: store information necessary for calculation of a power consumption at a first acceleration/deceleration setting that is based on the operation program and a power consumption at a second acceleration/deceleration setting, acquire an actual power consumption by calculation or actual measurement while the machine is operated at the first acceleration/deceleration setting; and calculate an expected power consumption by adding at least the actual power consumption and a power consumption increment/decrement corresponding to a change in acceleration/deceleration resulting from a change from the first acceleration/deceleration setting to the second acceleration/deceleration setting. The method of calculating an expected power consumption makes it possible to calculate an expected value of expected power consumption with improved accuracy.

### EXPLANATION OF REFERENCE NUMERALS

10: Numerically Control machine tool
20: Numerical control device
30: Servo control unit
40: Motor
50: External equipment
201: Program storage unit
2012: Command Analysis unit
203: Interpolation unit
204: Acceleration/deceleration control unit
205: Command output unit
206: Setting value storage unit
207: Expected power consumption calculation unit
208: Setting change unit
209: FB acquisition unit
210: Actual power consumption acquisition unit
211: Display setting unit
212: Display unit
301: Subtracter
302: Position control unit
303: Subtracter
304: Speed control unit
305: Subtracter
306: Current control unit
307: Integrator

1. A numerical control device comprising:
a program storage unit configured to store an operation program for operating a machine;
an actual power consumption acquisition unit configured to acquire an actual power consumption by calculation or actual measurement while the machine is operated at a first acceleration/deceleration setting that is based on the operation program;
an expected power consumption calculation unit configured to calculate an expected power consumption by adding at least the actual power consumption and a power consumption increment/decrement corresponding to a change in acceleration/deceleration resulting from a change from the first acceleration/deceleration setting to a second acceleration/deceleration setting;
a setting value storage unit configured to store at least a part of information necessary for the expected power consumption calculation unit to calculate a power consumption at the first acceleration/deceleration setting and a power consumption at the second acceleration/deceleration setting; and
a display unit configured to display the actual power consumption and the expected power consumption.

2. The numerical control device according to claim 1,
wherein
the numerical control device is connected to a servo control device that operates the machine,
the numerical control device includes a feedback acquisition unit configured to acquire feedback information from the servo control device, the feedback information including a detection voltage and a detection current or a detection current and a detection speed, and
the actual power consumption acquisition unit acquires the actual power consumption by calculation using the feedback information.

3. The numerical control device according to claim 1, comprising:
a display setting unit configured to make a display setting for the display unit to display the actual power consumption and the expected power consumption for each period set.

4. The numerical control device according to claim 3,
wherein
the display setting unit includes a period setting unit that sets the period and a period dividing unit that divides the period set by the period setting unit, and
the display setting unit makes a display setting for the display unit to display the actual power consumption and the expected power consumption for each period divided.

5. The numerical control device according to claim 1, comprising:
a setting change unit configured to change the first acceleration/deceleration setting to the second acceleration/deceleration setting,
wherein
the setting change unit changes the second acceleration/deceleration setting, and
the expected power consumption calculation unit recalculates the expected power consumption based on the second acceleration/deceleration setting changed by the setting change unit.

6. The numerical control device according to claim 1, wherein the expected power consumption calculation unit acquires a power consumption of external equipment from the setting value storage unit and calculates the expected power consumption including the power consumption of the external equipment.

7. The numerical control device according to claim 1, wherein
the expected power consumption calculation unit calculates the expected power consumption by totalizing: the actual power consumption; an increment/decrement before and after a change from the first acceleration/deceleration setting to the second acceleration/deceleration setting, with respect to a power consumption at a constant speed;
and an increment/decrement before and after the change from the first acceleration/deceleration setting to the second acceleration/deceleration setting, with respect to a power consumption at a time of acceleration/deceleration.

8. The numerical control device according to claim 7,
wherein
the first and second acceleration/deceleration settings are set for linear acceleration/deceleration,
the numerical control device includes a setting change unit configured to change the first acceleration/deceleration setting to the second acceleration/deceleration setting, and
the setting change unit changes a time constant at the time of acceleration/deceleration.

9. The numerical control device according to claim 7, wherein
the first and second acceleration/deceleration settings are set for bell-shaped acceleration/deceleration,
the numerical control device includes a setting change unit configured to change the first acceleration/deceleration setting to the second acceleration/deceleration setting, and
the setting change unit changes a primary acceleration/deceleration time and a secondary acceleration/deceleration time at the time of acceleration/deceleration, or a time constant or a change in speed at the time of acceleration/deceleration.

10. The numerical control device according to claim 7, wherein
the first and second acceleration/deceleration settings are set for exponential acceleration/deceleration,
the numerical control device includes a setting change unit configured to change the first acceleration/deceleration setting to the second acceleration/deceleration setting, and
the setting change unit changes a time constant and a finally-reachable speed at the time of acceleration/deceleration.

11. A method of calculating an expected power consumption using a computer that functions as a numerical control device and includes a program storage unit storing an operation program for operating a machine, the method causing the computer to perform operations comprising:
storing information necessary for calculation of a power consumption at a first acceleration/deceleration setting that is based on the operation program and a power consumption at a second acceleration/deceleration setting;
acquiring an actual power consumption by calculation or actual measurement while the machine is operated at the first acceleration/deceleration setting; and
calculating an expected power consumption by adding at least the actual power consumption and a power consumption increment/decrement corresponding to a change in acceleration/deceleration resulting from a change from the first acceleration/deceleration setting to the second acceleration/deceleration setting.
